(19) United States
(12) Patent Application Publication
(10) Pub. No.: US 2011/0311239 A1
(43) Pub. Date: Dec. 22, 2011

(54) REPLACEMENT TONER CARTRIDGE MANAGEMENT APPARATUS, REPLACEMENT TONER CARTRIDGE MANAGEMENT SYSTEM, IMAGE FORMING APPARATUS, REPLACEMENT TONER CARTRIDGE MANAGEMENT METHOD, AND RECORDING MEDIUMS

(75) Inventor: Atsushi Kewai, Toyokawa-shi (JP)

(73) Assignee: KONICA MINOLTA BUSINESS TECHNOLOGIES, INC., Chiyoda-ku (JP)

(21) Appl. No.: 13/164,101

(22) Filed: Jun. 20, 2011

(30) Foreign Application Priority Data
Jun. 22, 2010 (JP) 2010-141262

(51) Int. Cl. G03G 15/08; G03G 21/00

(52) U.S. Cl. 399/12

(57) ABSTRACT

A replacement toner cartridge management apparatus comprising: a remaining toner information obtainer that obtains remaining toner information of a toner cartridge loaded on an image forming apparatus which the replacement toner cartridge management apparatus can access via a communication circuit; a life information obtainer that obtains life information of an expendable item for image forming which receives toner supply from the toner cartridge loaded on the image forming apparatus, when there is a need to replace a toner cartridge, based on the remaining toner information obtained by the remaining toner information obtainer; a determiner that determines a right type of replacement toner cartridge based on the life information obtained by the life information obtainer; and an output portion that outputs an instruction to deliver a replacement toner cartridge of the type determined by the determiner.

This application claims priority under 35 U.S.C. §119 to Japanese Patent Application No. 2010-141262 filed on Jun. 22, 2010, the entire disclosure of which is incorporated herein by reference in its entirety.

### BACKGROUND OF THE INVENTION

1. Field of the Invention

The present invention relates to a replacement toner cartridge management apparatus that determines a right type of replacement toner cartridge when there is a need to deliver to the user, a replacement toner cartridge to be loaded on their image forming apparatus; a replacement toner cartridge management system employing the replacement toner cartridge management apparatus; an image forming apparatus employed in the toner cartridge management system; a replacement toner cartridge management method; a recording medium having a replacement toner cartridge management program stored thereon to make a computer of a replacement toner cartridge management apparatus implement the replacement toner cartridge management method; and a recording medium having a replacement toner cartridge management program stored thereon to make a computer of an image forming apparatus implement the replacement toner cartridge management method.

2. Description of the Related Art

The following description sets forth the inventor's knowledge of related art and problems therein and should not be construed as an admission of knowledge in the prior art.

Conventionally, if the remaining toner in a toner cartridge loaded on an image forming apparatus such as an electrophotographic copier, a digital photo printer, or a multifunctional machine called MFP (Multi Function Peripheral), is lower than a predetermined level, the image forming apparatus determines that the toner cartridge nearly runs out of toner (the toner cartridge is in toner near empty state) and displays for the user a message stating that the toner cartridge nearly runs out of toner, on a display panel provided thereon. Noticing this message, the user prepares a replacement toner cartridge, or places an order for a replacement toner cartridge if not having any ones in stock.

Meanwhile, in recent years, an image forming apparatus connected with a management apparatus to exchange information with has been more commonly used in a remote management system (for example, Japanese Unexamined Patent Publication No. 2002-297969). In many cases, a retailer of image forming apparatuses or a provider of office supplies have their own management apparatus in their own place, in order to collect, store, and manage for their business, various types of information including toner near empty information from a plurality of image forming apparatuses in their users' places. Being connected with the image forming apparatuses, the management apparatus is capable of recognizing that the toner cartridges nearly run out toner and that these are replaced with new ones.

In some cases, the management apparatus is further connected with an order receiving apparatus receiving orders for a replacement toner cartridge (for example, Japanese Unexamined Patent Publication No. 2008-271231). In such a case, the management apparatus further transmits an order to the order receiving apparatus, so that a replacement toner cartridge will be delivered to the user. In other words, this is exactly a system to automatically deliver a replacement toner cartridge to users while they need not bother to place an order for it.

In recent years, a trickle development device employing a trickle developing method has been more commonly loaded on image forming apparatuses.

A trickle development device will be briefly described hereinbelow. It is an advantage of the two-component developing method that, since toner and carrier are charged to a predetermined polarity by being frictionally contacted each other, the toner is subjected to a lower level of stress than the one-component developing method using one-component developing agent. It is another advantage that carrier particles which surface area is larger than that of toner particles, hardly become dirty by letting toner particles attached to the surface of themselves. However, after a long period of use, carrier particles become dirty with toner particles attached to their surface (also referred to as spent), and the toner therefore gradually loses its charge. As a result, a toner stain or a toner scatter occurs, which is very troublesome. There is an idea to increase the amount of carrier in order to extend the life of a two-component development device, but it is not preferable since the device would need to be larger.

In order to resolve the problems with two-component developing agent, there is a technology (for example, Japanese Unexamined Patent Publication No. H59-100471) having been more commonly used in recent years; a trickle development apparatus that prevents the increase in deteriorated carrier by gradually receiving new developing agent and also gradually discharging old developing agent with a deteriorated capability of keeping charge. This trickle development apparatus is configured to set the changeable amount of its containing developing agent almost at a particular level by discharging the excess of deteriorated developing agent. This trickle development apparatus sets its containing carrier's capability of keeping charge almost at a particular level by gradually replacing deteriorated carrier with new one.

As described above, in a trickle developing method, a trickle development device maintains its containing carrier's age at a particular level by receiving both new toner and a little bit of new carrier from a toner cartridge filled with toner and a small amount of carrier, while discharging the excess of old carrier. This leads to a much longer life of the trickle development device.

The trickle development device needs to load a special toner cartridge for trickle development which is filled with toner and a small amount of carrier (about 20% of the amount of the developing agent); however, a smaller number of pages can be printed with use of such a special toner cartridge than with use of a toner cartridge filled with only toner, because of their difference in the amount of toner. Therefore, in terms of cost efficiency, a toner cartridge filled with only toner has an advantage over a special toner cartridge for trickle development.

By the way, the trickle development device eventually reach the end of life because of its mechanical deterioration such as bearing wear and deterioration of sealing material; however, when it reaches the end of life, its containing developing agent is still serviceable enough since the extent of deterioration has been saturated at a particular level by that time. Therefore, in terms of cost efficiency, it is preferred to use a toner cartridge filled with only toner in the last stage of the life of the trickle development device, as long as the trickle development device reaches the end of life because of its mechanical deterioration before the development agent.

However, in the conventional trickle developing method, even when a trickle development device nearly reaches the end of life because of its mechanical deterioration and needs to be replaced with a new one, a special toner cartridge for trickle development which is filled with both toner and carrier is still delivered as a replacement toner cartridge and used. This is definitely poor in cost efficiency.

Photoreceptors accepting toner developed thereon by the development devices is exactly in the same situation.

That is, while the developing agent is deteriorated and the toner loses its charge, a photoreceptor can make up for the short of charge, as long as it is new, with high capability of keeping charge. Therefore, although an ordinary toner cartridge filled with only toner also can be used, it is not cost-efficient to use a special toner cartridge for trickle development which is filled with both toner and carrier even in the early stage of the life of the photoreceptor.

The description herein of advantages and disadvantages of various features, embodiments, methods, and apparatus disclosed in other publications is in no way intended to limit the present invention. Indeed, particular features of the invention may be capable of overcoming particular disadvantages, while still retaining some or all of the features, embodiments, methods, and apparatus disclosed therein.

### SUMMARY OF THE INVENTION

The preferred embodiments of the present invention have been developed in view of the above-mentioned and/or other problems in the related art. The Preferred embodiments of the present invention can significantly improve upon existing methods and/or apparatuses.

It is an object of the present invention to provide a replacement toner cartridge management apparatus that is capable of determining the most cost-efficient type of replacement toner cartridge based on the age and the cost of an image forming supply unit such as a development device or a photoreceptor loaded on an image forming apparatus, when there is a need to deliver a replacement toner cartridge.

It is another object of the present invention to provide a replacement toner cartridge management system that is capable of determining the most cost-efficient type of replacement toner cartridge based on the age and the cost of an image forming supply unit such as a development device or a photoreceptor loaded on an image forming apparatus, when there is a need to deliver a replacement toner cartridge.

It is yet another object of the present invention to provide an image forming apparatus that is capable of determining the most cost-efficient type of replacement toner cartridge based on the age and the cost of an image forming supply unit such as a development device or a photoreceptor loaded on an image forming apparatus, when there is a need to deliver a replacement toner cartridge.

It is still yet another object of the present invention to provide a replacement toner cartridge management method that is capable of determining the most cost-efficient type of replacement toner cartridge based on the age and the cost of an image forming supply unit such as a development device or a photoreceptor loaded on an image forming apparatus, when there is a need to deliver a replacement toner cartridge.

It is further still yet another object of the present invention to provide a recording medium having a replacement toner cartridge management program stored thereon to make a computer of a replacement toner cartridge management apparatus implement the replacement toner cartridge management method.

It is further still yet another object of the present invention to provide a recording medium having a replacement toner cartridge management program stored thereon to make a computer of an image forming apparatus implement the replacement toner cartridge management method.

According to a first aspect of the present invention, a replacement toner cartridge management apparatus includes:

a remaining toner information obtainer that obtains remaining toner information of a toner cartridge loaded on an image forming apparatus which the replacement toner cartridge management apparatus can access via a communication circuit;

a life information obtainer that obtains life information of an expendable item for image forming which receives toner supply from the toner cartridge loaded on the image forming apparatus, when there is a need to replace a toner cartridge, based on the remaining toner information obtained by the remaining toner information obtainer;

a determiner that determines a right type of replacement toner cartridge based on the life information obtained by the life information obtainer; and

an output portion that outputs an instruction to deliver a replacement toner cartridge of the type determined by the determiner.

According to a second aspect of the present invention, an image forming apparatus includes:

a remaining toner information obtainer that obtains remaining toner information of a toner cartridge loaded on the image forming apparatus itself or a different image forming apparatus which this image forming apparatus can access via a communication circuit;

a life information obtainer that obtains life information of an expendable item for image forming which receives toner supply from the toner cartridge loaded on the image forming apparatus itself or the different image forming apparatus, when there is a need to replace a toner cartridge, based on the remaining toner information obtained by the remaining toner information obtainer;

a determiner that determines a right type of replacement toner cartridge based on the life information obtained by the life information obtainer; and

an output portion that outputs an instruction to deliver a replacement toner cartridge of the type determined by the determiner.

According to a third aspect of the present invention, a replacement toner cartridge management system includes a replacement toner cartridge management apparatus and at least one image forming apparatus which can access to each other via a communication circuit, wherein:

the image forming apparatus has one or more than one toner cartridge loaded thereon and comprises a transmitter that transmits remaining toner information of a toner cartridge to the replacement toner cartridge management apparatus; and

the replacement toner cartridge management apparatus comprises:

a receiver that receives the remaining toner information;

a life information obtainer that obtains life information of an expendable item for image forming which receives toner supply from the toner cartridge loaded on the image forming apparatus, when there is a need to replace a toner cartridge, based on the remaining toner information obtained by the remaining toner information obtainer;

a determiner that determines a right type of replacement toner cartridge based on the life information obtained by the life information obtainer; and

an output portion that outputs an instruction to deliver a replacement toner cartridge of the type determined by the determiner.

According to a fourth aspect of the present invention, a replacement toner cartridge management method implemented by a replacement toner cartridge management system in which a replacement toner cartridge management apparatus and at least one image forming apparatus can access to each other via a communication circuit, includes:

the image forming apparatus's having one or more than one toner cartridge loaded thereon and transmitting remaining toner information of the toner cartridge to the replacement toner cartridge management apparatus; and

the replacement toner cartridge management apparatus's:

receiving the remaining toner information;

obtaining life information of an expendable item for image forming which receives toner supply from the toner cartridge loaded on the image forming apparatus, when there is a need to replace a toner cartridge, based on the obtained remaining toner information;

determining a right type of replacement toner cartridge based on the obtained life information; and

outputting an instruction to deliver a replacement toner cartridge of the determined type.

According to a fifth aspect of the present invention, a transitory computer-readable recording medium has a replacement toner cartridge management program stored thereon to make a computer of a replacement toner cartridge management apparatus execute:

obtaining remaining toner information of a toner cartridge loaded on an image forming apparatus which the replacement toner cartridge management apparatus can access via a communication network;

obtaining life information of an expendable item for image forming which receives toner supply from the toner cartridge loaded on the image forming apparatus, when there is a need to replace a toner cartridge, based on the obtained remaining toner information;

determining a right type of replacement toner cartridge based on the obtained life information; and

outputting an instruction to deliver a replacement toner cartridge of the determined type.

According to a sixth aspect of the present invention, a transitory computer-readable recording medium has a replacement toner cartridge management program stored thereon to make a computer of an image forming apparatus execute:

obtaining remaining toner information of a toner cartridge loaded on the image forming apparatus itself or a different image forming apparatus which this image forming apparatus can access via a communication circuit;

obtaining life information of an expendable item for image forming which receives toner supply from the toner cartridge loaded on the image forming apparatus itself or the different image forming apparatus, when there is a need to replace a toner cartridge, based on the obtained remaining toner information;

determining a right type of replacement toner cartridge based on the obtained life information obtained; and

outputting an instruction to deliver a replacement toner cartridge of the determined type.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims.

### BRIEF DESCRIPTION OF THE DRAWINGS

The preferred embodiments of the present invention are shown by way of example, and not limitation, in the accompanying figures, in which:

FIG. 1 is a view illustrating a configuration of a toner cartridge management system according to one mode of implementing the present invention;

FIG. 2 is a view schematically illustrating a configuration of an image forming apparatus employed in the toner cartridge management system of FIG. 1;

FIG. 3 is a view to explain the image forming apparatus's machinery to feed toner in a sub-hopper from a toner cartridge;

FIG. 4 is a view to explain the image forming apparatus's machinery to feed toner in a development device from the sub-hopper;

FIG. 5 is a view schematically illustrating a configuration of a machinery to measure toner concentration;

FIG. 6 is a block diagram illustrating a configuration of a controller of the image forming apparatus of FIG. 2;

FIG. 7 is a block diagram illustrating a configuration of a toner cartridge management apparatus;

FIG. 8 is a flowchart representing a processing routine to detect a toner empty state;

FIG. 9 is a view to explain an example of an alert message displayed on an operation panel of the image forming apparatus;

FIG. 10 is a table illustrating the statuses based on remaining toner level;

FIG. 11 is a view to explain the overview of a procedure executed by the toner cartridge management system to determine a right type of replacement toner cartridge and output a delivery instruction;

FIG. 12 is a chart illustrating the correlation between the number of pages printed (print durability) that defines the age of the development device and the deterioration level of its containing developing agent;

FIG. 13 is a chart illustrating the correlation between the number of pages printed or a total rotation time (print durability) that defines the life of the photoreceptor drum and the deterioration levels of the developing agent and the photoreceptor drum;

FIG. 14 is a flowchart representing a processing routine executed by the toner cartridge management apparatus to determine a right type of replacement toner cartridge and output an order for it, starting when toner near empty occurs to any of the toner cartridges;

FIG. 15 is a flowchart representing a processing routine executed by the toner cartridge management apparatus to determine a right type of replacement toner cartridge and output an order for it, starting when toner near empty occurs to any of the toner cartridges loaded thereon.

### DETAILED DESCRIPTION OF THE PREFERRED EMBODIMENTS

In the following paragraphs, some preferred embodiments of the invention will be described by way of example and not limitation. It should be understood based on this disclosure that various other modifications can be made by those in the art based on these illustrated embodiments.

Hereinafter, one mode of implementing the present invention will be described with reference to the accompanying drawings.

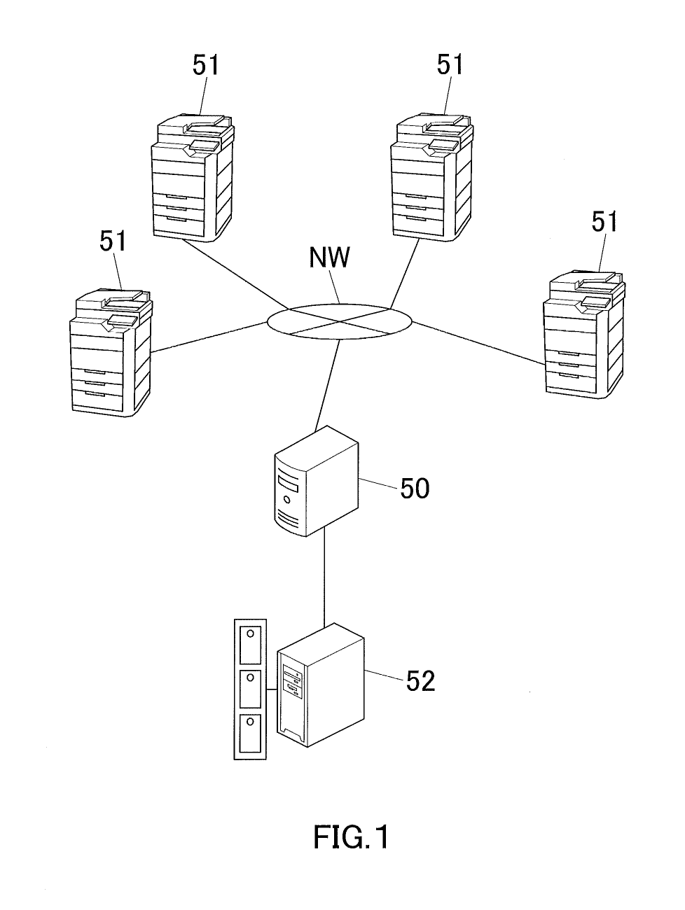

FIG. 1 is a view schematically illustrating a configuration of a toner cartridge management system according to one mode of implementing the present invention;

As illustrated in FIG. 1, the management system is basically provided with one or more than one image forming apparatus 51 and a management server 50, which are connected to each other via a communication circuit such as Internet. The management server 50 is further connected to an order receiving server 52 via Internet or the like.

The management server 50 is ordinarily provided in a service center or the like taking care of the image forming apparatuses 51 to manage information of the image forming apparatuses 51 by user accounts. More specifically, by communicating with the image forming apparatuses 51, the management server 50 monitors the remaining toner level(s) of a single toner cartridge or plural toner cartridges containing one color or different colors of toner that is a consumable resource, loaded on each of the image forming apparatuses 51. The image management server 50 further manages billing transactions and maintenance issues by collecting billing information such as number of pages printed and trouble information from the image forming apparatuses 51.

Users may use different types of image forming apparatuses; the image forming apparatuses 51 may be of different types. For example, the image forming apparatuses 51 may be printers, full-color copiers, monochrome copiers, and the like. Therefore, the image forming apparatuses 51 may load four toner cartridges containing four colors of toner: yellow (Y), magenta (M), cyan (C), and black (K), or only one toner cartridge containing one color of toner, black (K).

Furthermore, by monitoring unique uses and use patterns of the users, the management server 50 remotely controls the image forming apparatuses 51 for perfect performance based on settings and the like of the image forming apparatuses 51 stored on its own recording medium. The setting information of the image forming apparatuses 51 is integrally managed by the management server 50; it therefore can be changed by the management server 50 quite easily even if any of the image forming apparatuses 51 are located in remote areas.

The image forming apparatuses 51 and the management server 50 exchange information with each other, for example by e-mails via Internet.

Being further connected to the order receiving server 52, the management server 50 transmits an order for a replacement toner cartridge to the order receiving server 52 according to information indicating a need of toner cartridge replacement received from the image forming apparatuses 51, so that the order receiving server 52 can arrange for an automatic delivery.

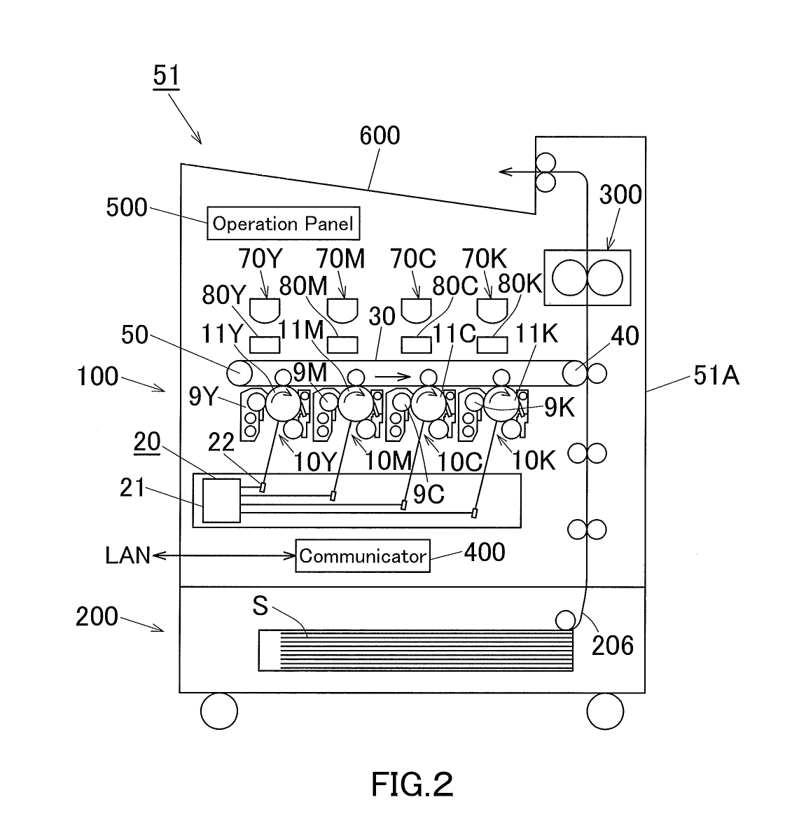

FIG. 2 is a view schematically illustrating a configuration of the image forming apparatus 51. In this example, a tandem color printer is employed as the image forming apparatus 51.

As illustrated in FIG. 1, the image forming apparatus 51 has a paper feeder 200 in the lower area of the body 51A, a color image former 100 in the middle area of the body 51A, and a paper discharger 600 in the upper area of the body 51A, respectively. A paper conveyance path 206 conveying toward the upper area, paper (a sheet of paper) S provided by the paper feeder 200 is extended all the way from the paper feeder 200 to the paper discharger 600.

The color image former 100 includes: a driving roller 40 and a driven roller 50 provided in the middle area of the vertical direction of the body 51A; a midway transfer belt 30 horizontally going around a group of the driving roller 40 and the driven roller 50 to run toward the direction indicated by arrow; and image forming units 10Y, 10M, 10C, and 10K containing yellow (Y), magenta (M), cyan (C), and black (K) of toner, respectively, provided along the belt's running direction.

Toner images formed by the image forming units 10Y, 10M, 10C, and 10K are layered together and transferred onto the transfer belt 30. In the second transfer process, the merged toner images are further transferred on the paper S passing trough the corner of the transfer belt 30 (on the extreme right of the body) via the paper conveyance path 206; the sheet S is conveyed to a fuser 300 to have the merged toner images fixed thereon.

The image forming units 10Y, 10M, 10C, and 10K forming images by the electrostatic copy method is provided with: a charger; a print head 21 including four laser diodes, a polygon mirror, a scanner lens, and the like; an exposure unit 20 including four reflection mirrors 22 and the like; development devices 9Y, 9M, 9C, and 9K; photoreceptor drums 11Y, 11M, 11C, and 11K; a transfer portion; and the like, which are all located in the vicinity of the image forming units themselves.

Above the image forming units 10Y, 10M, 10C, and 10K, toner cartridges 70Y, 70M, 70C, and 70K and sub-hoppers 80Y, 80M, 80C, and 80K are provided as supplier machineries that feed toner in the development devices 9Y, 9M, 9C, and 9K of the image forming units 10Y, 10M, 10C, and 10K, respectively.

The toner cartridges 70Y, 70M, 70C, and 70K are removablly loaded on the body 51A so as to be replaced with new ones when need. The toner cartridges 70Y, 70M, 70C, and 70K have a fuse attached thereto but not illustrated in this drawing; the body 51A detects an unused state of the toner cartridges when their fuses are conductive, and releases the unused state when the fuses are cut out. In other words, cutting the fuses, replacement of the toner cartridges is recognized.

In FIG. 1, a portion with the number 400 is a communicator communicating with external machines, and a portion with the number 500 is an operation panel provided with a set of keys and a display.

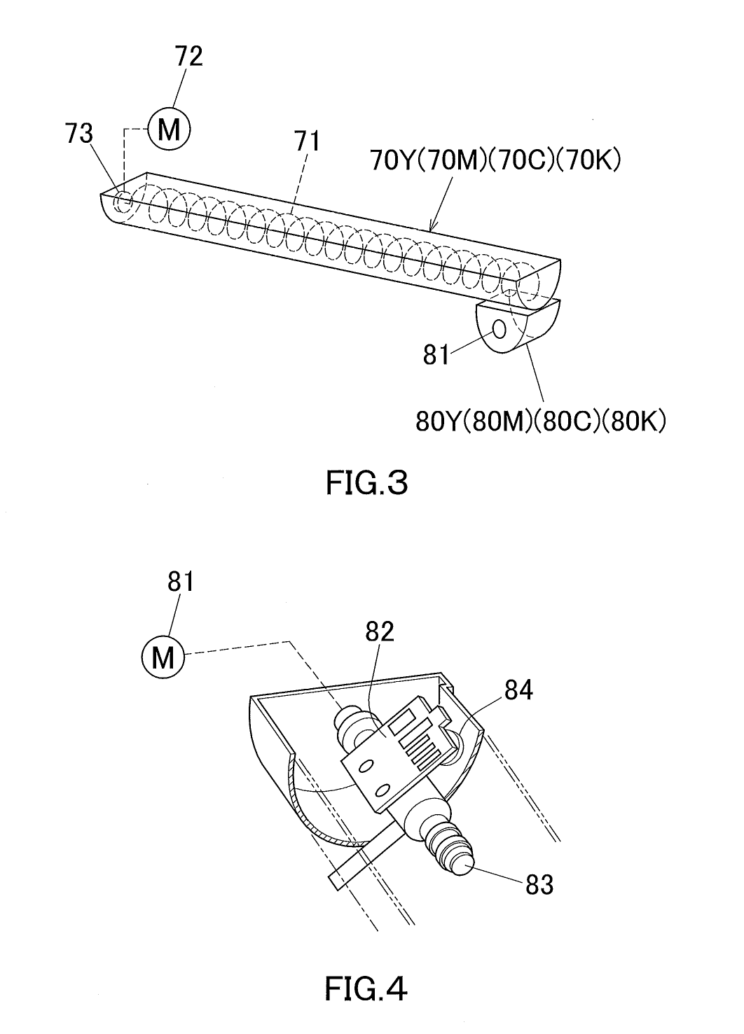

FIG. 3 is a view to explain a machinery to feed toner in the sub-hoppers 80Y, 80M, 80C, and 80K from the toner cartridges 70Y, 70M, 70C, and 70K, respectively.

As illustrated in FIG. 3, when the toner cartridges 70Y, 70M, 70C, and 70K are loaded on the body 51A, the sub-hoppers 80Y, 80M, 80C, and 80K open shutters on their top to receive toner from the toner cartridges 70Y, 70M, 70C, and 70K.

The toner cartridge 70Y, 70M, 70C, and 70K have a spiral spring 71 inside, and feed toner in the sub-hoppers 80Y, 80M, 80C, and 80K, respectively, by having their spiral springs 71 rotated by stepper motors (also referred to as cartridge motors) 72.

There provided two stepper motors 72 for the four spiral springs 71; one of the two works for the toner cartridges 70Y and 70M, and the other one works for the toner cartridges 70C and 70K. An even number of gears 73 are arranged between an inlet valve of the toner cartridges 70Y and 70C and an inlet valve for the toner cartridges 70K and 70M; when the stepper motors 72 perform normal rotation, the spiral springs 71 of the toner cartridges 70Y and 70C are properly rotated while the spiral springs 71 of the toner cartridges 70K and 70M are rotated idle, and when the stepper motors 72 perform reverse rotation, the spiral springs 71 of the toner cartridges 70Y and 70C are rotated idle while the spiral springs 71 of the toner cartridges 70K and 70M are properly rotated. Switching the stepper motors 72 between normal and reverse rotation determines whether or not to allow the toner cartridges 70Y, 70M, 70C, and 70K to feed toner.

FIG. 4 is a view to explain a machinery to feed toner in the development devices 9Y, 9M, 9C, and 9K from the sub-hoppers 80Y, 80M, 80C, and 80K.

As illustrated in FIG. 4, there provided one stepper motor (also referred to as sub-hopper motor) 81 for each of the sub-hoppers, the sub-hoppers 80Y, 80M, 80C, and 81K.

The sub-hoppers 80Y, 80M, 80C, and 80K feed toner in the development devices 9Y, 9M, 9C, and 9K, respectively, by having paddles 82 and spiral rollers 83 inside of themselves rotated by the sub-hopper motors 81. The remaining toner levels of the sub-hoppers 80Y, 80M, 80C, and 80K are detected by a toner empty sensor (piezoelectric sensor) 84.

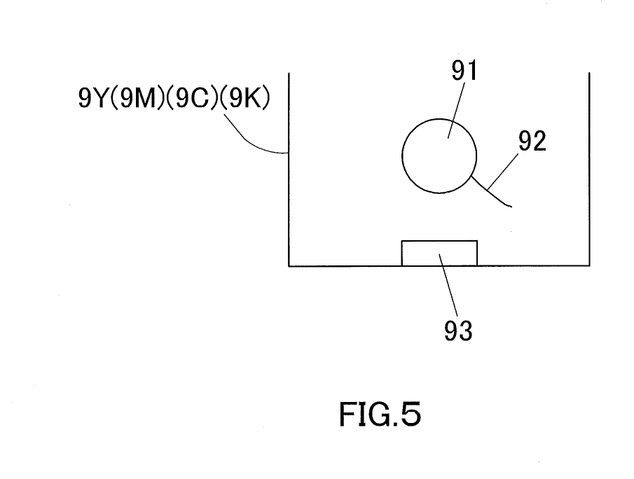

FIG. 5 is a view schematically illustrating a configuration of a machinery to measure toner concentration.

As illustrated in FIG. 5, the development devices 9Y, 9M, 9C, and 9K is filled with developing agent (toner and carrier); the developing agent in the development devices 9Y, 9M, 9C, and 9K is stirred by a Mylar plastic fin 92 attached to a motor-driven screw agitator 91. While the developing agent in the periphery of a toner concentration sensor 93 provided on the bottom of the development devices 9Y, 9M, 9C, and 9K is stirred by the Mylar plastic fin 92, new developing agent is let in the periphery of the toner concentration sensor 93. In other words, the developing agent in the periphery of the toner concentration sensor 93 is replaced with new one every other turn (ripple) of the screw agitator 91.

The toner concentration sensor 93 is a TCR sensor (magnetic sensor), for example. The toner concentration sensor 93 measures the toner concentration of the developing agent by reading out the magnetic permeability of iron included in the carrier of a unit volume of the developing agent in the periphery of the toner concentration sensor 93. That is, the higher a converted digital value (10-bit resolution) of an analog signal read out by the toner concentration sensor 93 is, the lower the toner concentration is.

The development devices 9Y, 9M, 9C, and 9K employ a trickle developing method in this mode of embodied implementation. In a trickle developing method, a development device consumes toner for developing images while receiving new toner and carrier, i.e. while gradually replacing deteriorated carrier with new one, in order to set its containing carrier's capability of keeping charge almost at a particular level, as described above. This leads a much longer life of the trickle development device.

An explanation of the configuration of a trickle development device is omitted here since it is a well-known technology.

In a trickle development device, the toner cartridges 70Y, 70M, 70C, and 70K are ordinarily filled with both toner and carrier in order to feed new carrier in the development devices 9Y, 9M, 9C, and 9K. Specifically, in this mode of embodied implementation, the toner cartridges 70Y, 70M, 70C, and 70K may be filled with only toner depending on the time for replacing the toner cartridges themselves and the age of the development devices 9Y, 9M, 9C, and 9K and the photoreceptor drums 11Y, 11M, 11C, and 11K. That will be further described in detail later.

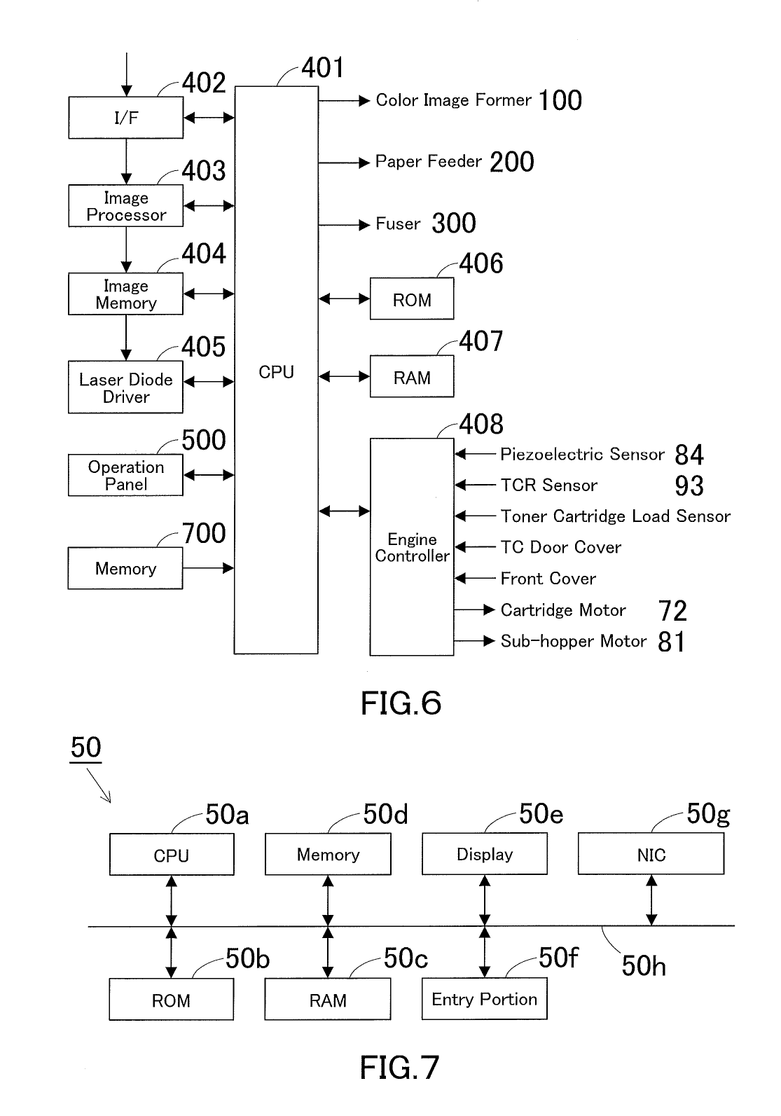

FIG. 6 is a block diagram illustrating a configuration of a controller of the image forming apparatus 51.

As illustrated in FIG. 6, the controller includes a CPU 401, a communication interface (I/F) 402, an image processor 403, an image memory 404, a laser diode driver 405, an operation panel 500, a recording medium 700, a ROM 406, a RAM 407, and an engine controller 408, as primary members.

The CPU 401 integrally controls all operations of the image forming apparatus 51. Also, the CPU 401 reads out a necessary program from the ROM 406; converts image data by the image processor 403; and writes and reads image data in and out from the image memory 404. Furthermore, the CPU 401 contributes to smooth printing operation by nicely arranging the times of a series of sequential operations of the color image former 100, the paper feeder 200, and the like. Furthermore, the CPU 401 detects (determines) a toner near empty state and an empty state of the toner cartridge 70Y, 70M, 70C, and 70K based on various information inputted from the engine controller 408; arranges the time of detecting (determining) a toner near empty state based on an indicated amount of fed toner and print log data; and displays a predetermined message stating about the time for replacing the toner cartridges 70Y, 70M, 70C, and 70K, on the operation panel 500.

The communication I/F 402 serves to connect the image forming apparatus 51 to a LAN such as a LAN card or a LAN board, and externally receives data to be printed out according to a print job and transfers it to the image processor 403.

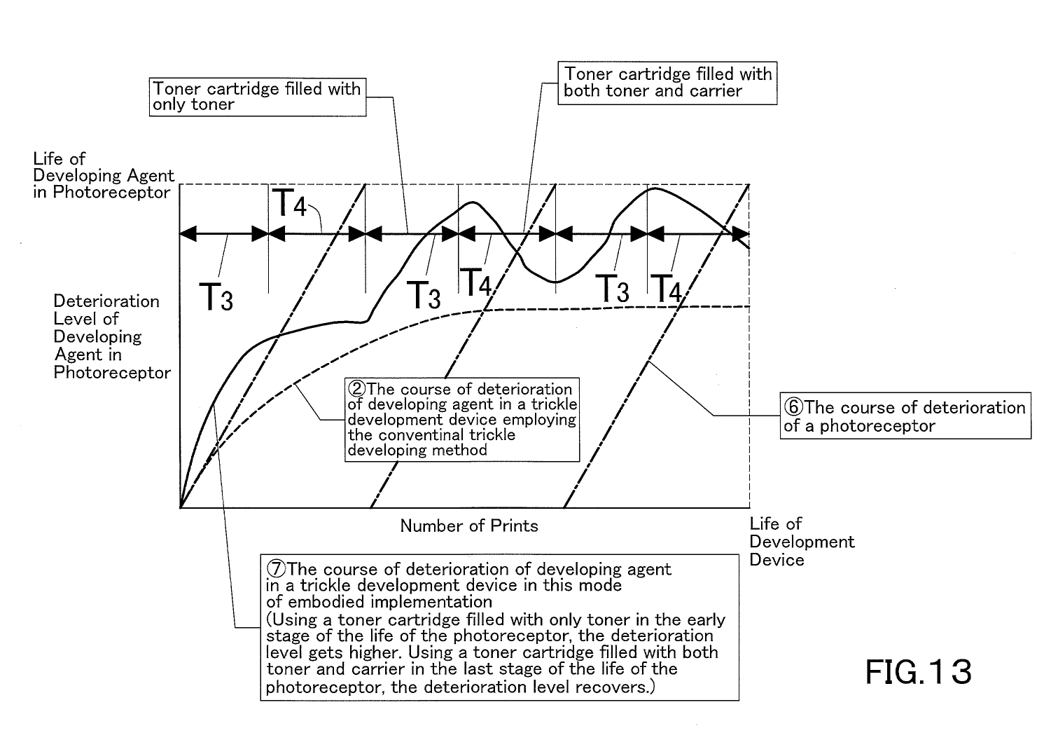

Also, the communication I/F 402 transmits toner empty information, alert information, trouble information, and information of various printing events to the management server 50 managing the image forming apparatus 51 (see FIG. 13) via Internet, and receives data and an instruction from the administration server 50.

Receiving data to be printed out according to a print job from the communication I/F 402, the image processor 403 converts the data into Y, M, C, and K image data objects for color reproduction and outputs the image data objects to the image memory 404 to have them stored thereon.

Reading out Y, M, C, and K image data objects from the image memory 404, the laser diode driver 405 drives the laser diodes of the exposure unit 20.

The operation panel 500 allows users to perform entry operations and displays various messages for them.

The recording medium 700 stores print log data, toner cartridge replacement log data, and the like, as well as various other data and applications.

The ROM 406 stores programs to control image forming operation and other data such as a table serving for toner supply control, toner empty detection control, and other controls.

The RAM 407 serves as a work area for the CPU 402.

Receiving signals and state information from the toner empty sensor 84, the TCR sensor 93, a toner cartridge loading sensor (not illustrated in the drawing), a TC door sensor (not illustrated in the drawing), a front cover (not illustrated in the drawing), the cartridge motors 72, the sub-hopper motors (not illustrated in the drawing), and the like, the engine controller 408 controls printing operation.

FIG. 7 is a block diagram illustrating a configuration of the management server 50 employed in the toner cartridge management system of FIG. 1.

The management server 50 is provided with a CPU 50a, a ROM 50b, a RAM 50c, a display 50e, an entry portion 50f, a network interface card (NIC) 50g, and the like, which are connected to each other via a system bus 50h.

The CPU 50a integrally controls the entire management server 50 by executing programs stored on the ROM 50b. Specifically, in this mode of embodied implementation, the CPU 50a collects from each of the image forming apparatuses 51, information of the remaining toner levels of the toner cartridges 70Y, 70M, 70C, and 70K and information indicating that the toner cartridges 70Y, 70M, 70C, and 70K have been replaced with new ones, and manages the information. Also, when there is a need to deliver a replacement toner cartridge, for example when receiving remaining toner information indicating a toner cartridge loaded on an image forming apparatus 51 becomes nearly empty, the CPU 50a controls various operations, for example transmitting to the image forming apparatus 51 an inquiry for the age of the development devices 9Y, 9M, 9C, and 9K and the photoreceptor drums 11Y, 11M, 11C, and 11K; determining a right type of replacement toner cartridge based on the age; and outputting a delivery instruction.

The ROM 50b is a recording medium that stores programs and data for the CPU 50a to execute processing.

The ROM 50c is a recording medium that provides a work area for the CPU 50a to execute processing according to an operation program.

The recording medium 50d is, for example, a hard disk drive, and stores various data, applications, and the like. Specifically, in this mode of embodied implementation, the recording medium 50d stores remaining toner information of the toner cartridges 70Y, 70M, 70C, and 70K loaded on the image forming apparatus 51, which is rewritable thereon.

The display 50e is, for example, a CRT display or a liquid-crystal display, and displays various messages, entry accepting screens, selection screens, and other screens for administrator-level users and other users.

The entry portion 50f serves for administrator-level users and other users to perform entry operation, and includes a keyboard, a mouse, and the like.

The network interface card 50g serves as a communicator that exchanges data with the image forming apparatuses 51 and the order receiving server 52 via Internet.

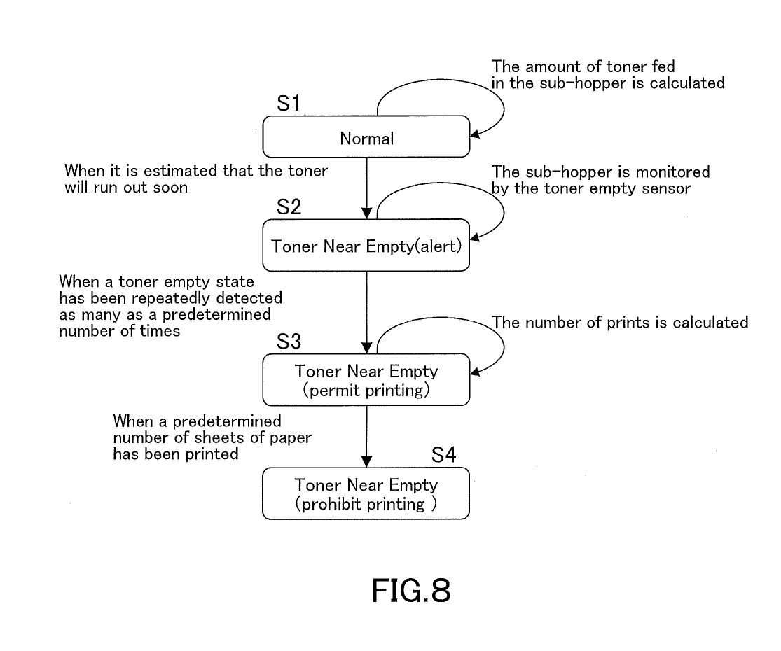

FIG. 8 is a flowchart representing a processing routine to detect a toner empty state, executed by the image forming apparatuses 51.

In FIG. 8, the remaining toner levels of the toner cartridges 70Y, 70M, 70C, and 70K slowly go down with feeding of toner; the toner cartridges 70Y, 70M, 70C, and 70K eventually run out of toner (become in toner empty state).

There are the four states depending on remaining toner level: “normal” (Step S1), “toner near empty (alert)” (Step S2), “toner empty (permit printing)” (Step S3), and “toner empty (prohibit printing)” (Step S4).

Unlike “toner near empty (alert)” (Step S2), “toner empty (permit printing)” (Step S3), and “toner empty (prohibit printing)” (Step S3), “normal” (Step S1) means that the toner cartridges 70Y, 70M, 70C, and 70K and the sub-hoppers 80Y, 80M, 80C, and 80K are sufficiently filled with toner. In these four states including the state of “normal” (Step S1), the CPU 401 accumulates the rotation quantum numbers of the cartridge motors 72, and estimates the amount of toner fed in the sub-hoppers 80Y, 80M, 80C, and 80K based on the rotation quantum numbers.

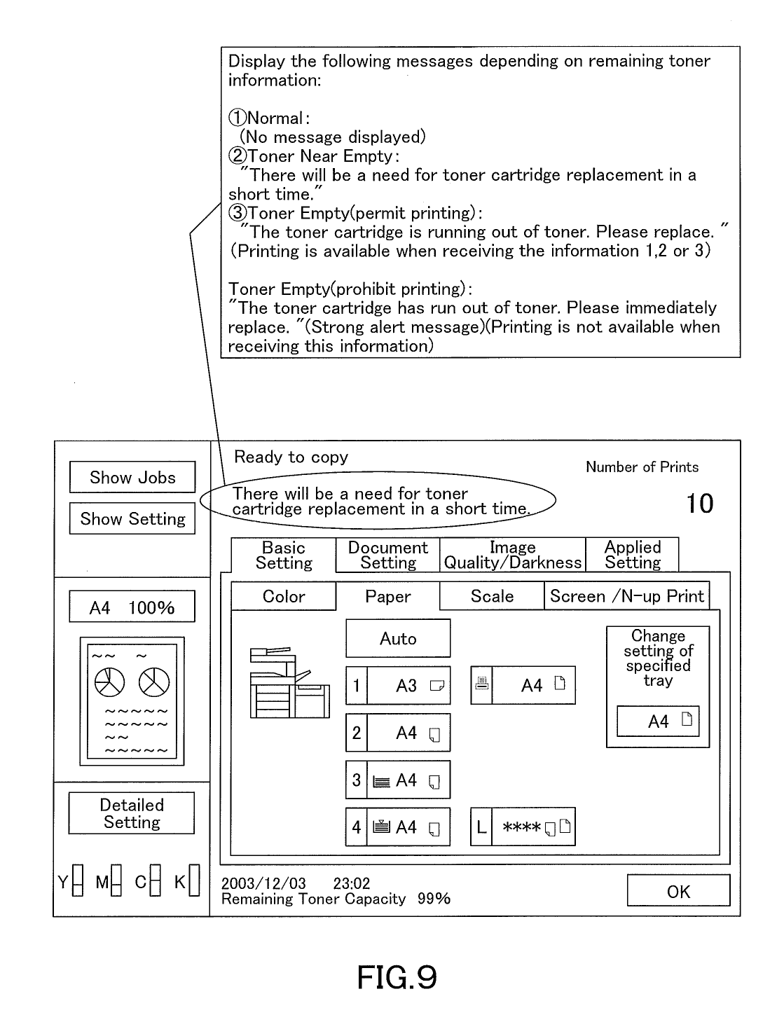

The CPU 401 determines the state as “toner near empty (alert)” (Step S2) if estimating that the toner cartridges 70Y, 70M, 70C, and 70K nearly run out of toner based on the estimated amount of toner fed in the sub-hoppers 80Y, 80M, 80C, and 80K. In the state of “toner near empty (alert)”, as illustrated in FIG. 9, an alert message stating that toner will run out in a short time is displayed on the operation panel 500 so that the user will be encouraged to prepare a replacement toner cartridge. After that, thousands of pages still can be printed using the toner cartridges 70Y, 70M, 70C and 70K before “toner empty (prohibit printing)” is detected, users therefore have enough time to prepare a replacement toner cartridge even when need to place an order because of no replacement toner cartridges in stock.

The CPU 401 determines the state as “toner empty (permit printing)” (Step S3) when the toner empty sensor 84 has repeatedly detected a toner empty state of the sub-hoppers 80Y, 80M, 80C, and 80K as many as a predetermined number of times. In this state, the toner cartridges 70Y, 70M, 70C, and 70K have no toner left inside while the sub-hoppers 80Y, 80M, 80C, and 80K still contain toner enough for as many as 100 printed pages approximately, and printing is therefore permitted.

The CPU 401 determines the state as “toner empty (prohibit printing)” (Step S4) when the sub-hoppers 80Y, 80M, 80C, and 80K run out of toner by further consuming it for a predetermined number of printed pages after “toner empty (permit printing)” is detected. In this state, printing is prohibited.

In the state of “toner near empty (alert)” (Step S2) and “toner empty (permit printing)” (Step S3), as illustrated in FIG. 9, an alert message is displayed on the operation panel 500 to let the user know that the toner will run out soon. In the state of “toner empty (prohibit printing)” (Step S4), a strong alert message is displayed on the operation panel 500 to let the user know that the toner has run out, and printing is prohibited.

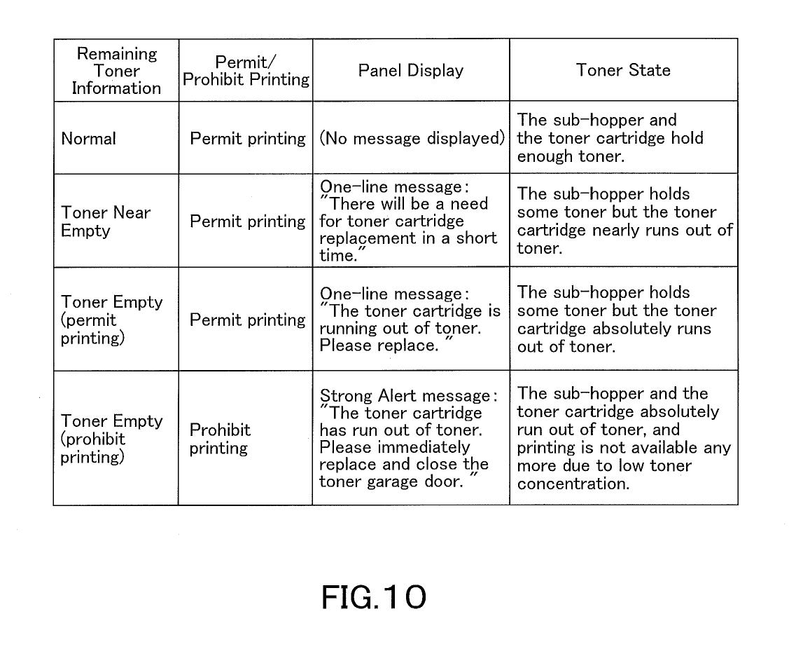

These states depending on remaining toner level: normal, toner near empty, toner empty (permit printing), and toner empty (prohibit printing) (described in Steps S1 to S4, respectively) are incorporated in a table illustrated in FIG. 10.

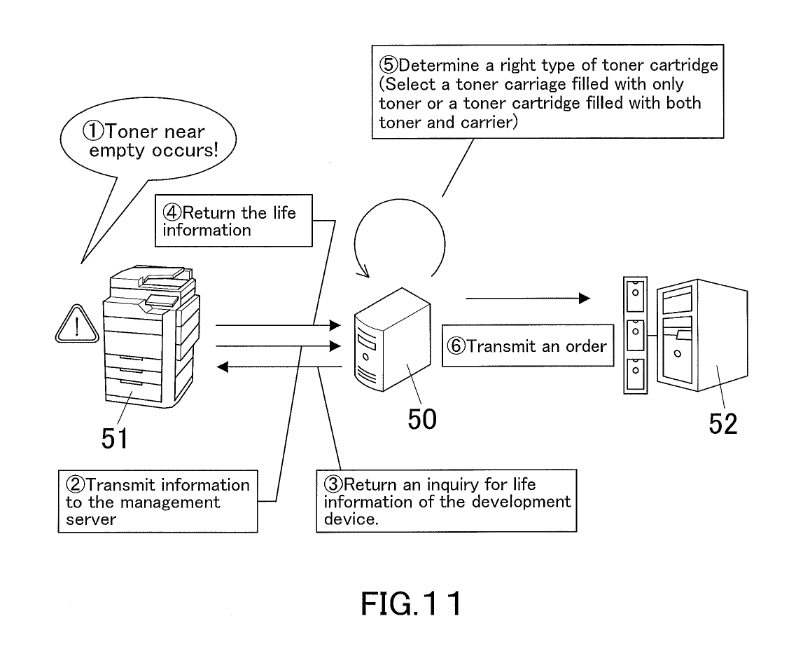

FIG. 11 is a view to explain the overview of a procedure to determine a right type of replacement toner cartridge in place of the toner cartridges 70Y, 70M, 70C, and 70K and output a delivery instruction.

In this example, when toner near empty occurs to any of the toner cartridges loaded the image forming apparatuses 51, i.e. when it is determined that an instruction to deliver a replacement toner cartridge should be outputted, the management server 50 examines life information of its matching development device 9Y, 9M, 9C, or 9K. And based on the life information, the management server 50 determines to deliver whether a toner cartridge filled with only toner or a toner cartridge filled with both toner and carrier.

Initially, toner near empty occurs to one of the image forming apparatuses 51 (circled number 1 in FIG. 11). Then the image forming apparatus 51 transmits information indicating the occurrence of toner near empty to the management server 50 that is connected to the image forming apparatus via a communication circuit (circled number 2).

Receiving the information from the image forming apparatus 51, the management server 50 returns thereto an inquiry for life information of its matching development device (circled number 3), and accordingly, the image forming apparatus 51 returns the life information (circled number 4).

Based on the life information received therefrom, the management server 50 determines a right type of replacement toner cartridge (circled number 5) and transmits an order for a toner cartridge of that type to the order receiving server 52 (circled number 6).

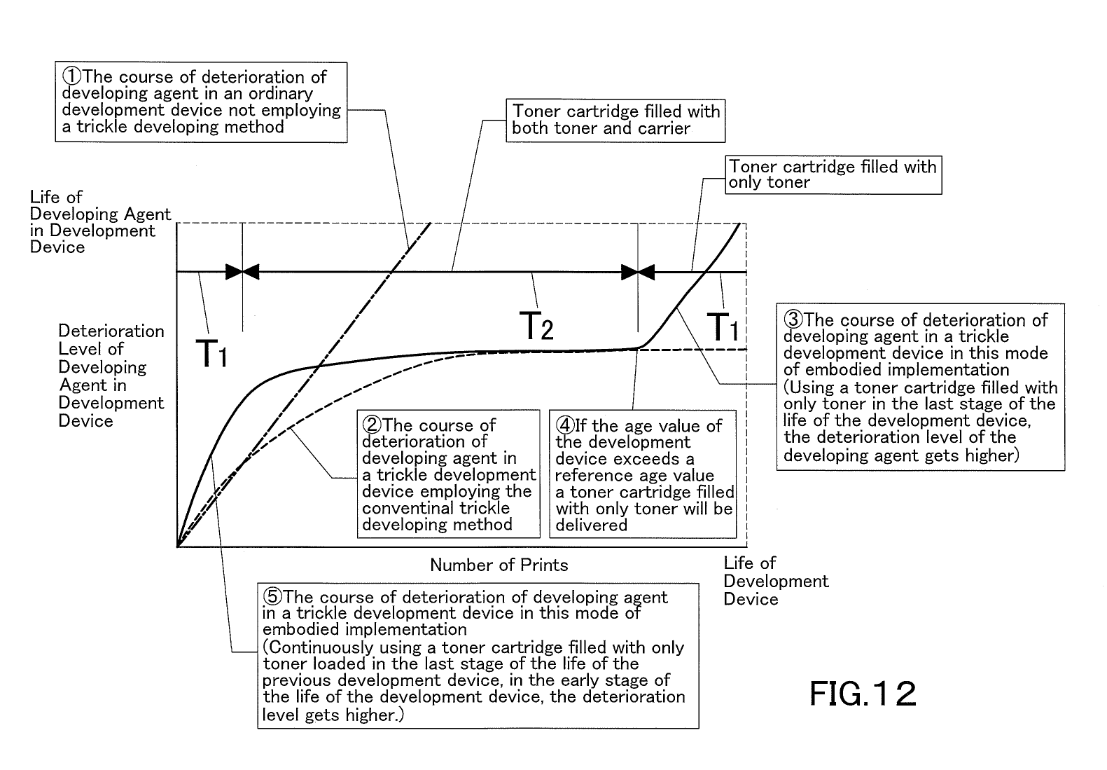

Hereinafter, the age of the development devices 9Y, 9M, 9C, and 9K and a right type of replacement toner cartridge will be described with reference to FIG. 12.

FIG. 12 is a chart illustrating the correlation between the number of pages printed that defines the age value of the development device (print durability) and the deterioration level of its containing developing agent.

A chained line with circle number 1 indicates the course of deterioration of developing agent in an ordinary development device that does not employ a trickle developing method. The more pages are printed, the more deteriorated carrier becomes because of fiction against the agitating machinery inside of the development device.

With a development device not employing a trickle developing method, deteriorated carrier loses its capability of keeping charge due to fiction against toner; the toner loses its charge quantity because of the deterioration of carrier; and a toner stain and a toner scatter easily occur and lead to poor print quality and contamination inside the development device, respectively, which is very troublesome. And eventually, when the toner becomes unable to maintain its charge quantity at a predetermined level because of deterioration of the carrier, the developing agent reaches the end of life, i.e. the development device reaches the end of life. The image forming apparatuses 51 is not capable of measuring the actual deterioration level of carrier; the image forming apparatus 51 determines that the development device reaches the end of life when having printed a particular number of pages, i.e. when the development device has worked enough.

On the other hand, a dashed line with circle number 2 refers to a deterioration curve indicating the course of deterioration of developing agent in a trickle development device that employs the conventional trickle developing method. In a conventional trickle developing method, a trickle development device receives new toner and a little bit of new carrier from a toner cartridge filled with both toner and a small amount of carrier, while discharging the excess of old carrier which is to be stored on a waste toner box. And while the trickle development device repeats this over and over, the extent of deterioration of its containing carrier is saturated at a particular deterioration level. Therefore, when a particular number of pages have been printed, the trickle development device reaches the end of life because of its mechanical deterioration such as bearing wear and deterioration of sealing material. A solid line with circled number 3 refers to a deterioration curve indicating the course of deterioration of developing agent in a trickle development device in this mode of embodied implementation. This deterioration curve mostly looks like the one with circled number 2 (does not look like that in the early stage, the reasons for which will be later described), because the trickle development device receives new toner and carrier from a special toner cartridge for trickle development which is filled with both toner and carrier, exactly the same as described above in the conventional trickle developing method.

When the development device 9Y, 9M, 9C, or 9K nearly reaches the end of life because of its mechanical deterioration, i.e. when a particular number of pages have been printed, a toner cartridge for the development device is replaced with a new one filled with only toner (circled number 4). After that, the development device receives only toner and never replaces its containing carrier with new one, so the deterioration level of the developing agent in the development device gradually gets higher.

And the life of the development device eventually comes to an end because of the mechanical deterioration, and almost at the same time, the life of the developing agent comes to an end because of its deterioration; comprehensively, the development device reaches the end of life.

As is understood from this mechanism, when there is a need to deliver a replacement toner cartridge according to the occurrence of toner near empty to any of the toner cartridge 70Y, 70M, 70C, and 70K; a toner cartridge filled with only toner will be delivered as a replacement toner cartridge in the last stage of the life of the near empty development device 9Y, 9M, 9C, or 9K (when the age value is large). Therefore, in the last stage of the life of the development device, a toner cartridge filled with only toner can be used for advantage in cost efficiency, without affecting the life of the development device.

The development device eventually reaches the end of life and is replaced with a new one, but the toner cartridge filled with only toner is not replaced with a new one at the same time; in the early stage of the life of the new development device, the toner cartridge filled with only toner is continuously used for a period of time. In this case, the deterioration curve is sharper than that of the conventional trickle developing method, indicating the deterioration advances more quickly (circled number 5).

However, next time the toner cartridge should be replaced with a new one, the deterioration level of the developing agent gradually will recovers with use of a replacement toner cartridge filled with both toner and carrier. As described above, there are no problems with use of a toner cartridge filled with only toner, in the early stage of the life of the development device. For these reasons above, the image forming apparatuses 51 may preliminarily load toner cartridges filled with only toner.

All these things considered, in this mode of embodied implementation, as illustrated in FIG. 12, it is preferred to use a toner cartridge filled with only toner in the last stage of life of the development devices 9Y, 9M, 9C, and 9K and for a period between replacement of the development devices and replacement of the toner cartridge (during a period T1); it is preferred to use a toner cartridge filled with both toner and carrier during a period T2 other than the period T1.

For example, when toner near empty occurs to any of the toner cartridges: it is preferred to deliver a toner cartridge filled with only toner as a replacement toner cartridge, if it is judged based on life information of its matching development device 9Y, 9M, 9C, or 9K, that the development device nearly reach the end of life because of its mechanical deterioration, i.e. if the age value of its matching development device which is defined by the number of pages printed (print durability) is larger than a particular reference value. In this method having greatly improved its convenience, a toner cartridge filled with only toner can be used for advantage in cost efficiency, without affecting an original feature of the trickle development device: long life.

The chart was explained above with the development devices 9Y, 9M, 9C, and 9K; it also can be explained in the same way with the photoreceptor drums 11Y, 11M, 11C, and 11K in place of the development devices 9Y, 9M, 9C, and 9K.

Another mode of embodied implementation in which a right type of replacement toner cartridge is determined based on the age of the photoreceptor drums 11Y, 11M, 11C, and 11K, will be described below with reference to FIG. 13.

FIG. 13 is a chart illustrating the correlation between the number of pages printed or a total rotation time (print durability) which defines the age value of the photoreceptor drum and the deterioration levels of the developing agent and the photoreceptor drum. Although a method to measure the deterioration level of developing agent is different from that to measure the photoreceptor drums 11Y, 11M, 11C, and 11K, the courses of the developing agent and the photoreceptor drums are drawn on the same axis with the same length of life, for convenience sake.

In a trickle developing method, the development devices 9Y, 9M, 9C, and 9K have an independent configuration from the photoreceptor drums 11Y, 11M, 11C, and 11K. And the life of the development devices 9Y, 9M, 9C, and 9K is much longer than that of the photoreceptor drums 11Y, 11M, 11C, and 11K; the photoreceptor units including the photoreceptor drums 11Y, 11M, 11C, and 11K are usually replaced with new ones several times before the development devices 9Y, 9M, 9C, and 9K reach the end of life. With more total rotation time, the photoreceptor drums 11Y, 11M, 11C, and 11K gradually lose their capability of keeping charge because of cracks on their photosensitive layers; the photoreceptor drums 11Y, 11M, 11C, and 11K eventually reach the end of life when becoming unable to maintain their capability of keeping charge at a particular level. In the last stage of the life, the photoreceptor drums 11Y, 11M, 11C, and 11K have a lower capability of keeping charge than that when they were new. The low capability of keeping charge leads to difficulty in raising charged voltage due to charge leakage from cracks on the photoreceptors. In such a case, a toner stain easily occurs to the photoreceptor drums 11Y, 11M, 11C, and 11K, since a margin to prevent such a trouble hardly cannot be ensured enough.

Also, when developing agent nearly reach the end of life, a toner stain and a toner scatter easily occur and lead to poor print quality and contamination inside the development device, respectively, as previously described with reference to FIG. 12.

Specifically, it is preferred to use new developing event in the last stage of the life of the photoreceptor drums 11Y, 11M, 11C, and 11K, it does not mean that the reverse also holds true: even if the photoreceptor drums 11Y, 11M, 11C, and 11K receive developing agent from a toner cartridge filled with only toner in the early stage of life, there will be no problems since while the developing agent is deteriorated and the toner loses its charge, the photoreceptors can make up for the short of charge, as long as they are new, with their capability of keeping charge.

In FIG. 13, a chained line with circled number 6 indicates the course of the deterioration level of the photoreceptor drums 11Y, 11M, 11C, and 11K. The photoreceptor drums 11Y, 11M, 11C, and 11K get deteriorated in proportion to the total rotation time. When the total rotation time (the number of pages printed) becomes more than a particular value, the deterioration level returns to zero because the photoreceptor drums 11Y, 11M, 11C, and 11K are replaced with new ones. This cycle is repeated until the development devices 9Y, 9M, 9C, and 9K reach the end of life. In FIG. 13, a dashed line with circle number 2 refers to a deterioration curve indicating the course of deterioration of developing agent in the conventional trickle developing method. And a solid line with circle number 7 refers to a deterioration curve indicating the course of deterioration of developing agent in this mode of embodied implementation. The deterioration level of the developing agent gradually gets higher because of supply of only toner in the first half of the life of the photoreceptor drums 11Y, 11M, 11C, and 11K, meanwhile the deterioration level of the developing agent gradually recovers because of supply of both toner and carrier in the second half of the life of the photoreceptor drums 11Y, 11M, 11C, and 11K.

All these things considered, in this mode of embodied implementation, as illustrated in FIG. 13, it is preferred to use a toner cartridge filled with only toner in the first half of the life of the photoreceptor drums 11Y, 11M, 11C, and 11K (during a period T3); it is preferred to use a toner cartridge filled with both toner and carrier in the second half of the life of the photoreceptor drums 11Y, 11M, 11C, and 11K (during a period T4).

For example, when toner near empty occurs to any of the toner cartridges: it is preferred to deliver a toner cartridge filled with only toner as a replacement toner cartridge, if it is judged based on life information of the its matching photoreceptor drum 11Y, 11M, 11C, or 11K, that the photoreceptor drum will not reach the end of life any time soon because of its mechanical deterioration, i.e. if the age value of the its matching photoreceptor defined by the number of pages printed or the total rotation time (print durability) is smaller than a particular reference value. In this method having greatly improved its convenience, a toner cartridge filled with only toner can be used for advantage in cost efficiency, without affecting an original feature of the trickle development device: long life.

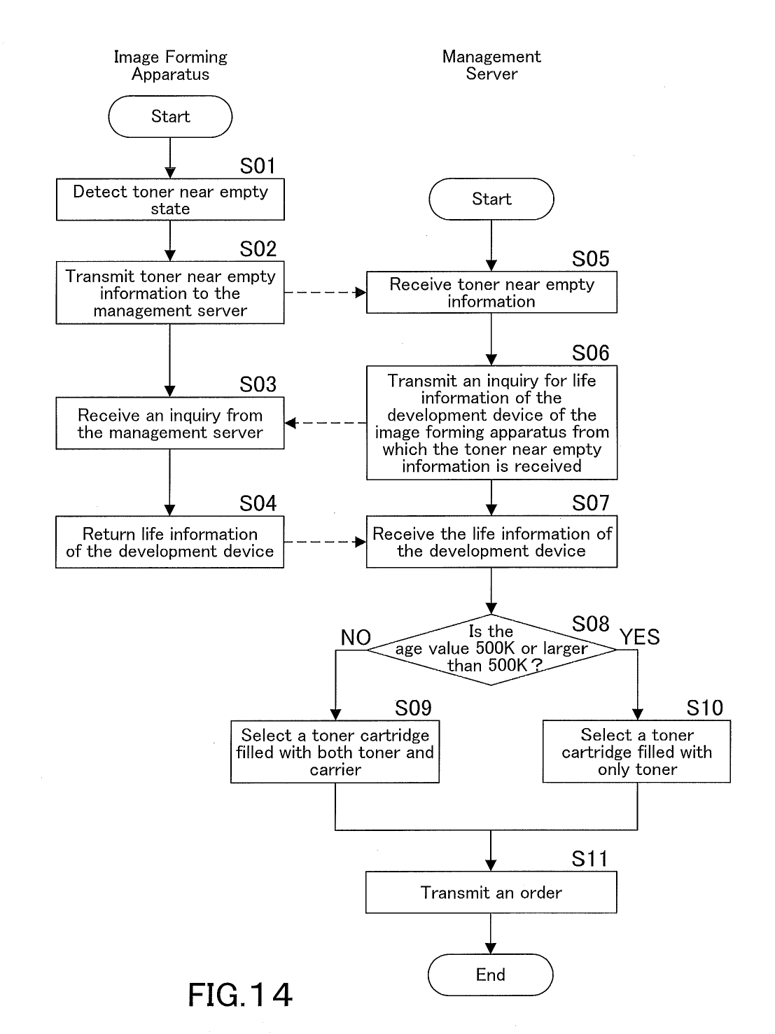

FIG. 14 is a flowchart representing a processing routine executed by the management server 50 to determine a right type of replacement toner cartridge and output an order for it, starting when toner near empty occurs to any of the toner cartridges, wherein a right type of replacement toner cartridge is determined based on life information of its matching development devices 9Y, 9M, 9C, or 9K. The processing routine is executed by the CPU 50a of the management server 50 according to an operation program stored on a recording medium such as the ROM 50b.

In Step S01, any of the image forming apparatuses 51 detects a toner near empty state, and then in Step S02, the image forming apparatus 51 transmits toner near empty information to the management server 50.

Receiving the toner near empty information in Step S05, the management server 50 returns to the image forming apparatus 51 an inquiry for life information of its matching development device in Step S06.

Receiving the inquiry in Step S03, the image forming apparatus 51 returns the life information to the management server 50 in Step S04.

Receiving the life information from the image forming apparatus 51 in Step S07, the management server 50 determines a right type of replacement toner cartridge based on the life information. Specifically, it is judged in Step S08 whether or not the age value of the development device is 500K or larger than 500K (K: constant), i.e. whether or not a particular number of pages defined by 500K have been printed. If the age value is smaller than 500K (NO in Step S08), it is determined that a toner cartridge filled with both toner and carrier should be delivered as a replacement toner cartridge in Step S09, since the development device will not reach the end of life any time soon. After that, the routine proceeds to Step S11.

If the age value is 500K or larger than 500K (YES in Step S08), it is determined that a toner cartridge filled with only toner should be delivered as a replacement toner cartridge in Step S10, since the development device nearly reach the end of life. After that, the routine proceeds to Step S11.

In Step S11, an order for a replacement toner cartridge of the determined type is transmitted to the order receiving server 52.

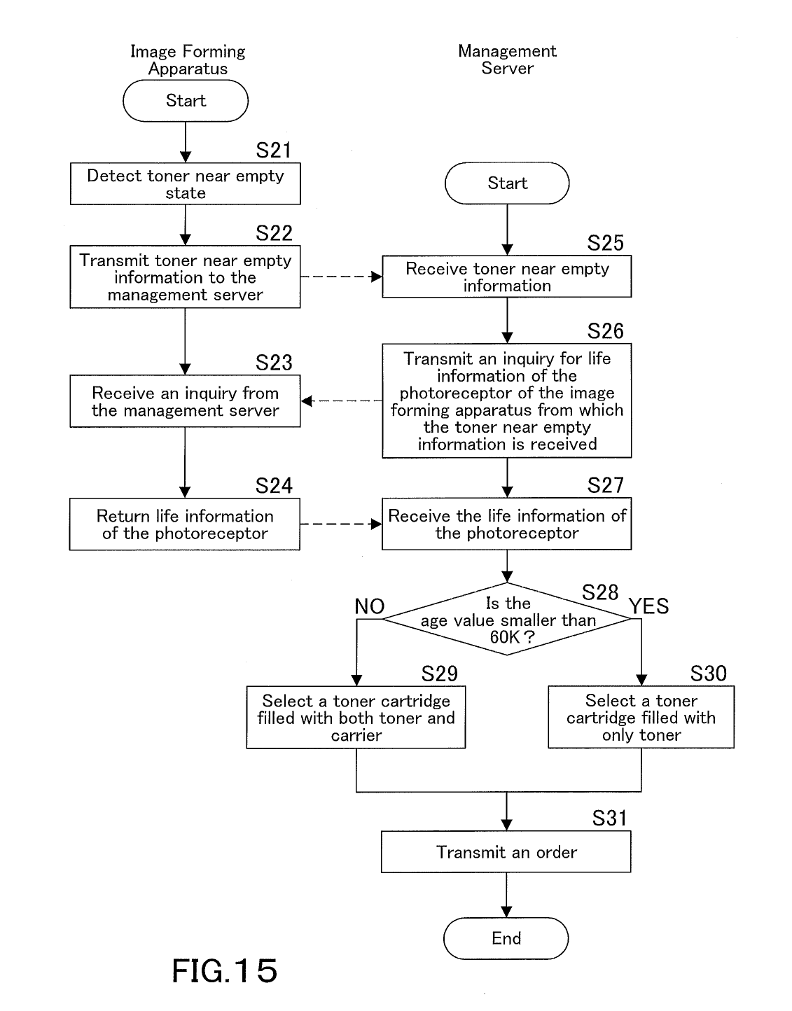

FIG. 15 is another flowchart representing a processing routine executed by the management server 50 to determine a right type of replacement toner cartridge and output an order for it, starting when toner near empty occurs to any of the toner cartridges loaded on the image forming apparatuses 51, wherein a right type of replacement toner cartridge is determined based on life information of its matching photoreceptor drums 11Y, 11M, 11C, or 11K. The processing routine is executed by the CPU 50a of the management server 50 according to an operation program stored on a recording medium such as the ROM 50b.

In Step S21, any of the image forming apparatuses 51 detects a toner near empty state, and then in Step S22, the image forming apparatus 51 transmits toner near empty information to the management server 50.

Receiving the toner near empty information in Step S25, the management server 50 returns to the image forming apparatus 51 an inquiry for life information of its matching photoreceptor drum in Step S26.

Receiving the inquiry in Step S23, the image forming apparatus 51 returns the life information to the management server 50 in Step S24.

Receiving the life information from the image forming apparatus 51 in Step S27, the management server 50 determines a right type of replacement toner cartridge based on the life information.

In this mode of embodied implementation, the photoreceptor drums 11Y, 11M, 11C, and 11K reach the end of life when 120K pages have been printed. Therefore, it is judged in Step S28 whether or not the age value of the photoreceptor drum is smaller than 60K (K: constant), i.e. whether or not the photoreceptor drum is in the first half of life. If the age value is smaller than 60K (YES in Step S28), it is determined that a toner cartridge filled with only toner should be delivered as a replacement toner cartridge in Step S30. After that, the routine proceeds to Step S31. And so, the photoreceptor drum receives developing agent from a toner cartridge filled with only toner in the first half of life. In this case, while the developing agent is deteriorated, the photoreceptor can contribute to proper image development with high capability of keeping charge.

In Step S28, if the age value is 60K or larger than 60K (NO in Step S28), it is determined that a toner cartridge filled with both toner and carrier should be delivered as a replacement toner cartridge in Step S29. After that, the routine proceeds to Step S31. In this case, if the photoreceptor drum receives developing agent from a toner cartridge filled with both toner and carrier in the second half of life, while the photoreceptor drum and the carrier are deteriorated, carrier supply can make up for the short of charge.

In Step S31, an order for a replacement toner cartridge of the determined type is transmitted to the order receiving server 52.

The modes of implementing the present invention have been described in the foregoing specification, which does not mean that the present invention shall be construed as limited to the particular forms disclosed.

For example, in the modes of embodied implementation, the management server 50 monitors the remaining toner levels of the toner cartridges, for example receiving toner near empty information of the toner cartridges; obtains life information of the development devices and the photoreceptor drums; determines a right type of replacement toner cartridge to deliver as a replacement toner cartridge; and outputs a delivery instruction (outputs an order). Alternatively, one of the image forming apparatuses 51 collectively having all the functions of the management server 50 in one, may monitor the remaining toner levels of the toner cartridges, for example receiving toner near empty information of the toner cartridges; obtain life information of the development devices and the photoreceptor drums; determine a right type of replacement toner cartridges to deliver as a replacement toner cartridge; and output a delivery instruction (output an order). In this alternative configuration, these operations described above are performed by the control of the CPU 401 of the image forming apparatus 51 according to an operation program.

Furthermore, in the modes of embodied implementation, there is the order receiving server 52, to which the management server 50 outputs a delivery instruction to the order receiving server 52. Alternatively, the management server 50 may output a message requesting for order placement, on the display 50e or on a display of another apparatus such as a, PC. In this case, an order placement operation is manually performed.

Furthermore, in the modes of embodied implementation, a right type of toner cartridge is determined when there is a need to deliver a replacement toner cartridge according to the occurrence of toner near empty. Alternatively, a right type of toner cartridge may be determined when there is a need to deliver a replacement toner cartridge according to the occurrence of toner near empty (permit printing) or depending on remaining toner level information.

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

While illustrative embodiments of the invention have been described herein, the present invention is not limited to the various preferred embodiments described herein, but includes any and all embodiments having equivalent elements, modifications, omissions, combinations (e.g. of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to”. In this disclosure and during the prosecution of this application, means-plus-function or step-plus-function limitations will only be employed where for a specific claim limitation all of the following conditions are present In that limitation: a) “means for” or “step for” is expressly recited; b) a corresponding function is expressly recited; and c) structure, material or acts that support that structure are not recited. In this disclosure and during the prosecution of this application, the terminology “present invention” or “invention” may be used as a reference to one or more aspect within the present disclosure. The language present invention or invention should not be improperly interpreted as an identification of criticality, should not be improperly interpreted as applying across all aspects or embodiments (i.e., it should be understood that the present invention has a number of aspects and embodiments), and should not be improperly interpreted as limiting the scope of the application or claims. In this disclosure and during the prosecution of this application, the terminology “embodiment” can be used to describe any aspect, feature, process or step, any combination thereof, and/or any portion thereof, etc. In some examples, various embodiments may include overlapping features. In this disclosure and during the prosecution of this case, the following abbreviated terminology may be employed: “e.g.” which means “for example”, and “NB” which means “note well”.

What is claimed is:

1. A replacement toner cartridge management apparatus comprising:
a remaining toner information obtainer that obtains remaining toner information of a toner cartridge loaded on an image forming apparatus which the replacement toner cartridge management apparatus can access via a communication circuit;
a life information obtainer that obtains life information of an expendable item for image forming which receives toner supply from the toner cartridge loaded on the image forming apparatus, when there is a need to replace a toner cartridge, based on the remaining toner information obtained by the remaining toner information obtainer;
a determiner that determines a right type of replacement toner cartridge based on the life information obtained by the life information obtainer; and
an output portion that outputs an instruction to deliver a replacement toner cartridge of the type determined by the determiner.

2. The replacement toner cartridge management apparatus as recited in claim 1, wherein:
the expendable item is a development device that employs a trickle developing method; and
the determiner selects either a first toner cartridge filled with or toner or a second toner cartridge filled with both toner and carrier, as a replacement toner cartridge, based on the life information of the development device.

3. The replacement toner cartridge management apparatus as recited in claim 2, wherein the determiner selects the first toner cartridge if the age value of the development device is larger than or equal to a first reference age value, and the second toner cartridge if the age value of the development device is smaller than a first reference age value.

4. The replacement toner cartridge management apparatus as recited in claim 1, wherein:
the expendable item is a photoreceptor that receives toner supply from a development device employing a trickle developing method; and
the determiner selects either a first toner cartridge filled with only toner or a second toner cartridge filled with both toner and carrier, as a replacement toner cartridge, based on the life information of the photoreceptor.

5. The replacement toner cartridge management apparatus as recited in claim 4, wherein the determiner selects the second toner cartridge if the age value of the photoreceptor is larger than or equal to a second reference age value, and the first toner cartridge if the age value of the photoreceptor is smaller than a second reference age value.

6. An image forming apparatus comprising:
a remaining toner information obtainer that obtains remaining toner information of a toner cartridge loaded on the image forming apparatus itself or a different image forming apparatus which this image forming apparatus can access via a communication circuit;
a life information obtainer that obtains life information of an expendable item for image forming which receives toner supply from the toner cartridge loaded on the image forming apparatus itself or the different image forming apparatus, when there is a need to replace a toner cartridge, based on the remaining toner information obtained by the remaining toner information obtainer;
a determiner that determines a right type of replacement toner cartridge based on the life information obtained by the life information obtainer; and
an output portion that outputs an instruction to deliver a replacement toner cartridge of the type determined by the determiner.

7. The image forming apparatus as recited in claim 6, wherein:
the expendable item is a development device that employs a trickle developing method; and
the determiner selects either a first toner cartridge filled with or toner or a second toner cartridge filled with both toner and carrier, as a replacement toner cartridge, based on the life information of the development device.

8. The image forming apparatus as recited in claim 7, wherein the determiner selects the first toner cartridge if the age value of the development device is larger than or equal to a first reference age value, and the second toner cartridge if the age value of the development device is smaller than a first reference age value.

9. The image forming apparatus as recited in claim 6, wherein:
the expendable item is a photoreceptor that receives toner supply from a development device employing a trickle developing method; and
the determiner selects either a first toner cartridge filled with only toner or a second toner cartridge filled with both toner and carrier, as a replacement toner cartridge, based on the life information of the photoreceptor.

10. The image forming apparatus as recited in claim 9, wherein the determiner selects the second toner cartridge if the age value of the photoreceptor is larger than or equal to a second reference age value, and the first toner cartridge if the age value of the photoreceptor is smaller than a second reference age value.

11. A replacement toner cartridge management system comprising a replacement oner cartridge management apparatus and at least one image forming apparatus which can access to each other via a communication circuit, wherein:
the image forming apparatus has one or more than one toner cartridge loaded thereon and comprises a transmitter that transmits remaining toner information of a toner cartridge to the replacement toner cartridge management apparatus; and
the replacement toner cartridge management apparatus comprises:
a receiver that receives the remaining toner information;
a life information obtainer that obtains life information of an expendable item for image forming which receives toner supply from the toner cartridge loaded on the image forming apparatus, when there is a need to replace a toner cartridge, based on the remaining toner information obtained by the remaining toner information obtainer;
a determiner that determines a right type of replacement toner cartridge based on the life information obtained by the life information obtainer; and
an output portion that outputs an instruction to deliver a replacement toner cartridge of the type determined by the determiner.

12. The replacement toner cartridge management system as recited in claim 11, wherein:
the expendable item is a development device that employs a trickle developing method; and
the determiner selects either a first toner cartridge filled with or toner or a second toner cartridge filled with both toner and carrier, as a replacement toner cartridge, based on the life information of the development device.

13. The replacement toner cartridge management system as recited in claim 12, wherein the determiner selects the first toner cartridge if the age value of the development device is larger than or equal to a first reference age value, and the second toner cartridge if the age value of the development device is smaller than a first reference age value.

14. The replacement toner cartridge management system as recited in claim 11, wherein:
the expendable item is a photoreceptor that receives toner supply from a development device employing a trickle developing method; and
the determiner selects either a first toner cartridge filled with only toner or a second toner cartridge filled with both toner and carrier, as a replacement toner cartridge, based on the life information of the photoreceptor.

15. The replacement toner cartridge management system as recited in claim 14, wherein the determiner selects the second toner cartridge if the age value of the photoreceptor is larger than or equal to a second reference age value, and the first toner cartridge if the age value of the photoreceptor is smaller than a second reference age value.

16. A replacement toner cartridge management method implemented by a replacement toner cartridge management system in which a replacement toner cartridge management apparatus and at least one image forming apparatus can access to each other via a communication circuit, comprising:
the image forming apparatus's having one or more than one toner cartridge loaded thereon and transmitting remaining toner information of the toner cartridge to the replacement toner cartridge management apparatus; and
the replacement toner cartridge management apparatus's:
receiving the remaining toner information;
obtaining life information of an expendable item for image forming which receives toner supply from the toner cartridge loaded on the image forming apparatus, when there is a need to replace a toner cartridge, based on the obtained remaining toner information;
determining a right type of replacement toner cartridge based on the obtained life information; and
outputting an instruction to deliver a replacement toner cartridge of the determined type.

17. A transitory computer-readable recording medium having a replacement toner cartridge management program stored thereon to make a computer of a toner cartridge management apparatus execute:
obtaining remaining toner information of a toner cartridge loaded on an image forming apparatus which the replacement toner cartridge management apparatus can access via a communication network;
obtaining life information of an expendable item for image forming which receives toner supply from the toner cartridge loaded on the image forming apparatus, when there is a need to replace a toner cartridge, based on the obtained remaining toner information;
determining a right type of replacement toner cartridge based on the obtained life information; and
outputting an instruction to deliver a replacement toner cartridge of the determined type.

18. A transitory computer-readable recording medium having a replacement toner cartridge management program stored thereon to make a computer of an image forming apparatus execute:
obtaining remaining toner information of a toner cartridge loaded on the image forming apparatus itself or a different image forming apparatus which this image forming apparatus can access via a communication circuit;
obtaining life information of an expendable item receiving toner supply from the toner cartridge loaded on the image forming apparatus itself or the different image forming apparatus, when there is a need to replace a toner cartridge, based on the obtained remaining toner information;
determining a right type of replacement toner cartridge based on the obtained life information obtained; and
outputting an instruction to deliver a replacement toner cartridge of the determined type.
